(19) United States
(12) Patent Application Publication
(10) Pub. No.: US 2004/0016578 A1
(43) Pub. Date: Jan. 29, 2004

(54) Tire engaging track

(76) Inventors: Yves St-Pierre, Wickham (CA); Francois Duquette, Drummondville (CA)

Correspondence Address: Ronald S. Kosie, BROUILLETTE KOSIE, 25th Floor, 1100 Rene-Levesque Boulevard West, Montreal, QC, H3B 5C9, CA

(21) Appl. No.: 10/202,390

(22) Filed: Jul. 25, 2002

(51) Int. Cl. B62D 55/04

(52) U.S. Cl. 180/9.26

(57) ABSTRACT

This invention relates to vehicles equipped with rubber tires used to drive over diverse types of terrain and, more particularly, to a tire track which consists in one or more rubber track segments, attached with a joint assembly and designed to accommodate any types of wheel diameter, thickness and ground surface, when installed on top of rubber tires. Each rubber track segment is made from a profiled outside layer and an inner layer comprising side guides to hold the track on the tire. Each segment is linked with the next one by a joint assembly using links and fastening means to ensure complete covering of the tires periphery.

### FIELD OF INVENTION

This invention relates to vehicles equipped with rubber tires used to drive over diverse types of terrain and, more particularly, to a tire track which consists in one or more rubber track segments, attached with a joint assembly and designed to accommodate any types of wheel diameter, thickness and ground surface, when installed on top of rubber tires.

### BACKGROUND OF THE INVENTION

Numerous types of vehicles are frequently used in terrain in which it is difficult for pneumatic or solid tires to operate. Both defence vehicles, such as tanks and amphibious vehicles, and civilian vehicles, such as tractors, skid steers and recreational vehicles, are sometime utilized on terrains which are very soft, for example sand surfaces or mud. Tires are not capable of efficient operation on such surfaces, as they tend to get stuck rather than riding across the surface.

Endless track vehicles have been developed for use on terrains in which pneumatic-tired vehicles are impractical. U.S. Pat. Nos. 3,361,488 and 3,688,858 show such endless track vehicles. In many types of terrain these vehicles provide improved performance relative to the performance of pneumatic-tired vehicles; still, difficulties are encountered with existing endless track vehicles.

Since metallic track usually produces high levels of noise, cause damage to roads and soil, have large weights, high manufacturing and maintenance cost, many track-laying vehicles are now driven and supported by rubber tracks. [NOTE: As used herein, the term “rubber” relates to any elastic and primarily non-metallic materials such as rubber, elastomers, or combinations thereof used in the manufacture of endless tracks].

Most rubber tracks are formed around a basic endless carcass or belt element having respective interior and exterior surfaces with a predetermined width dimension co-extensive with the track's just-mentioned overall track width. Terrain-contacting lugs are formed integral with the exterior surface of this basic belt element, such lugs having a predetermined lug-thickness dimension.

The rubber track equipped vehicle provides endless possibilities to its user on uneven, remote or muddy terrain. However, industrial, defence, recreational or personal vehicles still equipped with rubber tires sometimes have to be more polyvalent and need the capability to access difficult locations.

There is also a need to propose a system which would simplify the installation process, minimize the cost associated to installation of the endless track and minimize the de-tracking occurrences of rubber tracks, by still keeping all the advantages that were brought by the arrival of the rubber technology.

Recent track inventions which are destined for the rubber tire equipped vehicle market have put focus on developing endless rubber tracks. For example, Thomas (U.S. Pat. No. 6,390,564) and Bonko (U.S. Pat. No. 6,386,652) proposes tire track system with an endless rubber track comprising a centre lug which engages at the centre of two mounted tires per wheel, requiring the removal of one wheel and the use of special tools to install the endless rubber track. Deland (U.S. Pat. No. 6,267,453) presented an endless rubber track including side guides and evacuation means to allow accumulated debris to be expelled from the track.

Co-pending patent application of Deland proposes a solution to the rubber endless track installation problems with the help of a split wheel.

Side guides and multiple track segments were added to tire track assemblies with the inventions of Nordstrom et al. (U.S. Pat. No. 5,388,624 and U.S. Pat. No. 5,616,193) and McIntosh (U.S. Pat. No. 4,810,043) and Sjostrom (U.S. Pat. No. 6,394,562) but none of these invention described herein comprises a tire track assembly having an adjustable length. Nordstrom et al. uses a plurality of rubber tire supporting elements which requires the presence of a layer of low-friction material on the tire. Sjostrom uses a plurality of one-piece mouldings comprising the track and supporting element and McIntosh, a plurality of metal assemblies of tracks and joints.

### SUMMARY OF INVENTION

The objective of this invention is to provide an alternative to typical tracked vehicle for industrial, defence, recreational or personal uses by introducing a simple, easy to install, adjustable and versatile product destined for any vehicle equipped with rubber tires. The invention is particularly useful for smaller vehicles like skid steer.

The invention integrates the use of different track technologies into one product. In one embodiment, a plurality of rubber track segments coupled with the use of adjustable joint assemblies which comprises rods and different link sizes increases the track adjustability over the tires in a radial direction, thus providing the tire track equipped vehicle with the adjustments possibilities which are required due to tire tread wear.

For any track segment or joint replacement, only the concerned area needs to be removed and changed, since the joint assembly is made of rods and links which are easily removed and replaced in any remote locations with the use of standard tools. The joint design introduces different longitudinal link lengths due to variable attachment possibilities of the track segments, thus adapting to the defined perimeter of the wheel-track assembly with different increment possibilities. The adjustable joint assembly also minimizes the track openings to the accumulation of mud and debris between the tire and the track.

A well adjusted tire track still needs good lateral support, which is provided by the presence of plastic or metal side guides which encapsulate part of the tire side surfaces and at the same time, must not induce higher friction forces between the track and the tire, which would result in a tire tendency to disengage from the track.

Since the track assembly comprises a plurality of rubber track segments and joint assemblies, this invention covers a wide range of tire diameters. The width of the tire track assembly and side guide dimensions are determined by the type of tire.

### BRIEF DESCRIPTION OF THE FIGURES

FIG. 1 is an inner surface isometric view of a first embodiment of rubber track segments assembled with the use of different joint assemblies.

FIG. 2 is an outer surface isometric view of the rubber track segments shown in FIG. 1.

FIG. 3 is a side view of the rubber track segments shown in FIG. 1.

FIG. 4 is a section view along line 4-4 in FIG. 3.

FIG. 5 is an inner surface isometric view of the joint between two rubber track segments having a second embodiment.

FIG. 6 is an outer surface isometric view of the rubber track segments shown in FIG. 5.

FIG. 7 is an end view of the rubber track segment shown in FIG. 5.

FIG. 8 is a section view along line 8-8 in FIG. 7.

FIG. 9 is an outer surface isometric view of still another embodiment of a segment in accordance with the invention.

FIG. 10 is a top view of the outer surface of the rubber track shown in FIG. 9.

FIG. 11 is a side view of the rubber track shown in FIG. 9.

FIG. 12 is an outer surface isometric view of a joint assembly for use with the rubber track shown in FIG. 9.

FIG. 13 is a front view of the outer surface of the joint assembly shown in FIG. 12.

FIG. 14 is a side view of the joint assembly shown in FIG. 12.

FIG. 15 is an end view of the joint assembly shown in FIG. 12.

FIG. 16 is an exploded view of the assembly shown in FIG. 12 and the rubber track shown in FIG. 9.

FIG. 17 is a front top view of the assembly shown in FIG. 16.

### DETAILLED DESCRIPTION OF A PREFERED EMBODIMENT

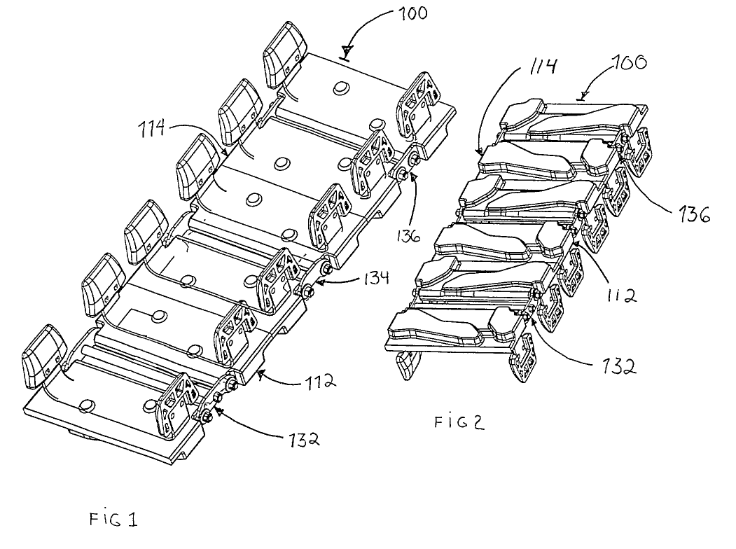

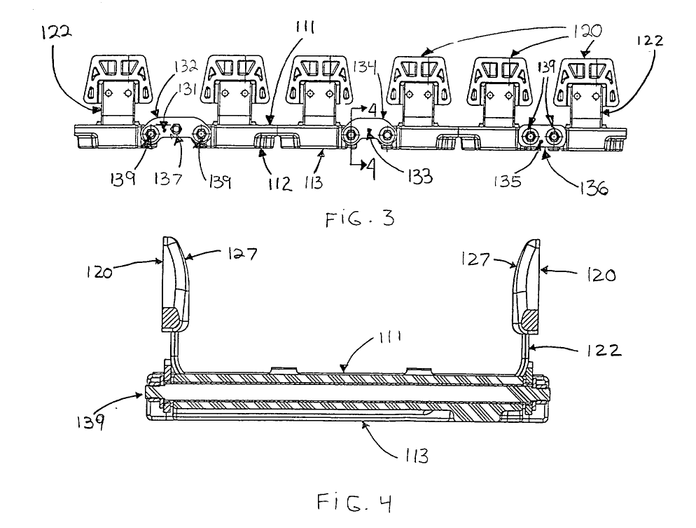

FIGS. 1 and 2 show the tire track assembly 100 in its first embodiment, which comprises rubber track segments 112 and 114 and joint assemblies 132, 134 and 136. Each track segment 112, 114 is made of rubber which is typically reinforced by fabric, cords and/or metallic plates. As shown in FIGS. 3 and 4, the track segment 112 comprises an inner surface 111 which faces the tire when installed and an outer surface 113 with a profile designed to adapt to various ground conditions. In this embodiment, any profile pattern is adaptable. A reinforcement plate 122 is moulded in the track, having protruding ends bended in a way to offer fixation support to the side guides 120.

FIG. 3 shows joint assemblies 132, 134, 136 which are constituted of side metal links 131, 133 and 135, attached to adjacent track segments. As illustrated in FIG. 4, connecting rods 139 are slid trough a hole in the track segment in a lateral direction and fastened to the side links 131, 133 or, 135, thus providing the required clamped junction in between two track segments. Any succession of side links may be used. Because they have different lengths, it is possible to provide a more precise adjustment over the tires.

The open gap in joints assemblies 132, 134, 136 is minimized to avoid mud and debris entrance between the tire and the track assembly 100, as illustrated in FIG. 3 with the use of small length links 133 and 135. When bigger gaps are created by longer side links 131, the use of lateral rods 137 between connecting rods 139 rigidifies the assembly and diminish the open gap in joint assembly 132.

The plastic or metal side guides 120 are fastened or mounted on the reinforcing plates 122 of the track segment 112 as shown in FIG. 4, in order to provide lateral support to the vehicle which is equipped with the tire track assembly 100, while offering the least friction forces when there is contact with the rubber tires. When the tire track 100 is assembled on at least two wheels, the side guides 120 begin their course along the tire with an incident angled profile 127 which prevents interference with the tire. As the side guides 120 reach the wheel curved portion of the tire track defined perimeter, that same angled profile 127 prevents the interference of two consecutive side guides 120 as they approach one another therefore, the gap dimension in between two consecutive side guides 120 is minimized and offers a good lateral reinforcement to the tire track assembly 100.

The tire track 100 is assembled over the vehicle's wheels without fully air blown tires. The adjustable joints assemblies 132, 134 and/or 136 are selected to provide a predetermined tension in the track 100 once the tire is inflated.

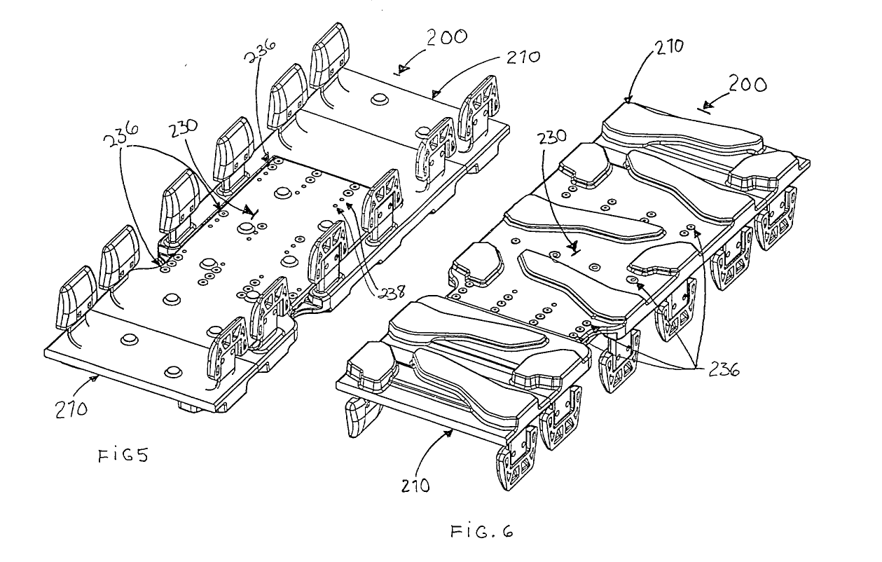

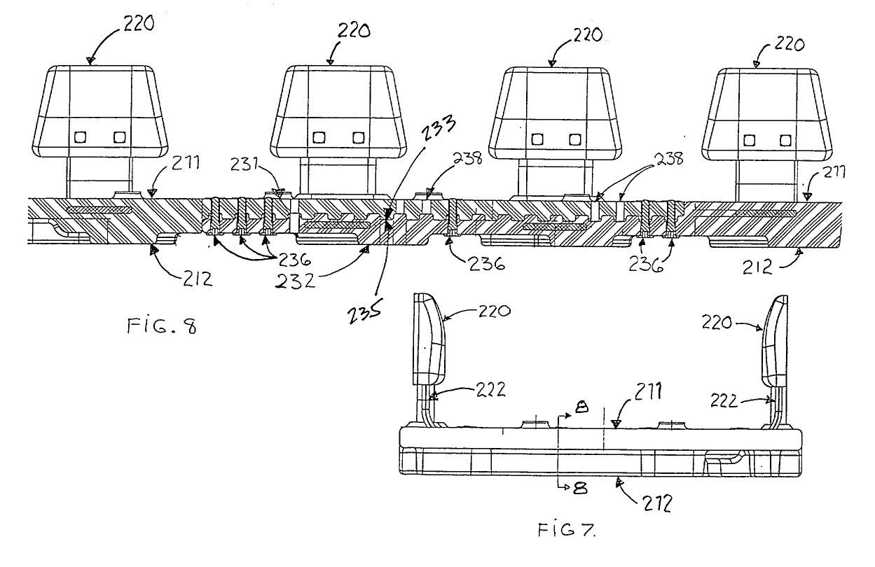

In a second embodiment, FIGS. 5 and 6 show the tire track assembly 200 comprising a single rubber track segment 210 with a an adjustable joint assembly area 230, located at the rubber track segment 210 extremities. Each track segment 210 is also made of rubber which is typically reinforced by fabric, cords or metallic plates. As shown in FIGS. 7 and 8, the track segment 210 comprises an inner surface 211 which faces the tire when installed and an outer surface 212 with a profile designed to adapt to various ground conditions. In the second embodiment, any profile pattern is also adaptable. A reinforcement plate 222 is moulded in the track, having protruding ends bended in a way to offer support to the side guides 220.

As shown in FIG. 8, rubber track segment of the second embodiment comprises on one end an area 231 comprising a plurality of ridges 233, which area 231 is thinner than the rest of the rubber track segment 210 and designed to mate with the other end area 232 comprising a plurality of grooves 235 which mate and fit around ridges 233. A series of holes disposed in rows 238 in the joint assembly area 230 are destined to offer adjustable attachment means to join area 231 to area 232 of the tire track assembly 200, since many hole rows in the protruding inner extremity area 231 offer various positioning possibilities to corresponding holes in rows 238 of the area 232.

As illustrated in FIGS. 5, 6 and 8, the fasteners 236 attach the two track extremities 231, 232. Although this embodiment has been described using a single track segment 210 wrapped around the tire(s), two or more segments 210 may be used to achieve the same result.

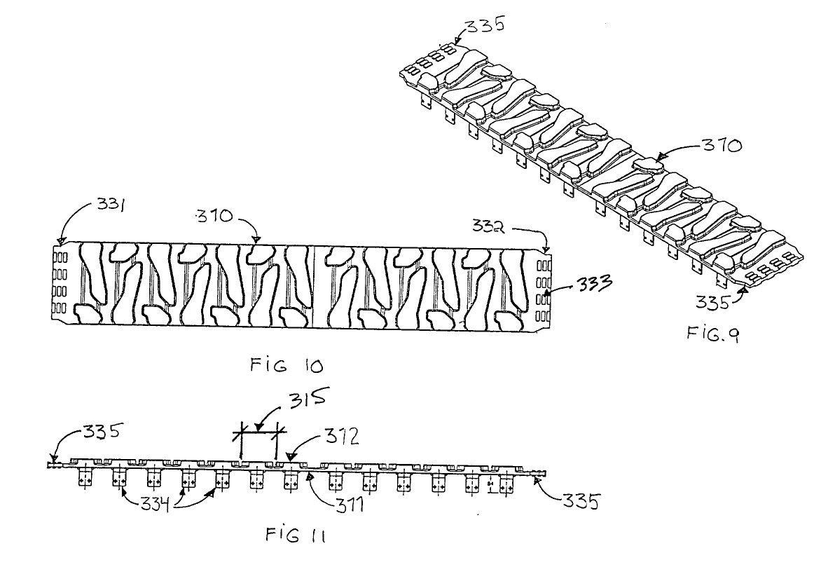

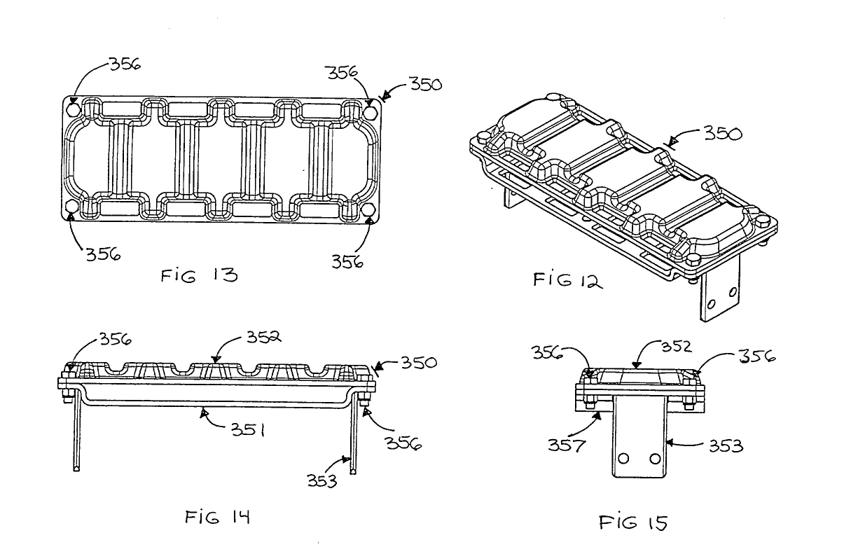

In a third embodiment shown in FIGS. 9, 10 and 11 a tire track segment 310 is made of rubber also typically reinforced by fabric, cords or metallic plates. Each rubber track segment 310 comprises an inner surface 311 which faces the tire when installed and an outer surface 312 with a profile designed to adapt to various ground conditions. In the third embodiment, any ground engaging profile pattern may be used. A reinforcement plate 334 is moulded in the track and has protruding ends bended in a way to offer support to the side guides 320 with fasteners 337 or other known means, as shown in FIG. 16. Each rubber track segment extremities 331, 332 can be the same, both having a plurality of protuberances 333 extending in rows across its width in order to ensure adjustability with the joint assembly 350.

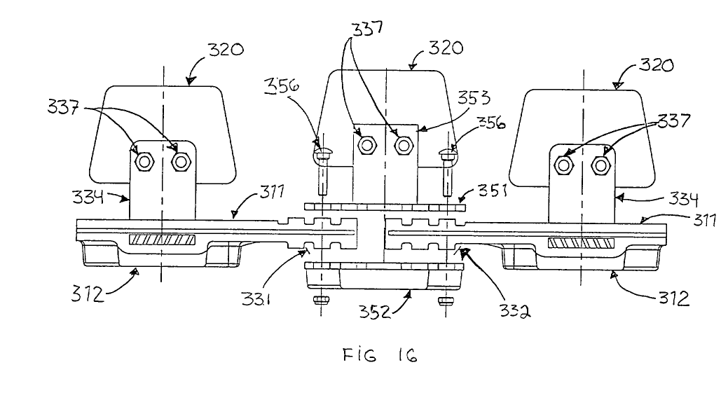

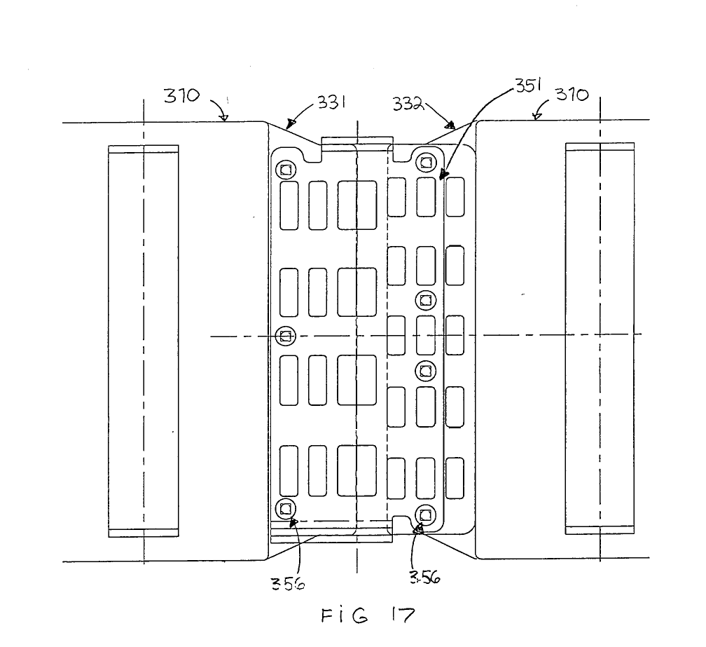

FIGS. 12, 13, 14 and 15 show a joint assembly 350 which is constituted of an inner 351 and an outer 352 metal plate and disposed one on top of the other, acting as a clamping device for overlapping extremity segments 331 and 332. The inner plate may also support a reinforcement bended plate 353 in order to also offer a support to the side guides 320.

As illustrated in FIGS. 16 and 17, the fasteners 356 and the joint assembly 350 clamp extremities 331 and 332 of a single rubber track segment 310 of adjoining rubber track segments 310 if a plurality of modules are used. The positioning of the two extremities 331 and 332 inside the joint assembly 350 provides adjustability to the tire track perimeter when assembled on the tires, due to the possibility of selecting engagement of the holes in the plates 351 and 352 with different rows of protuberances 333.

1- A track assembly for use with a tire equipped vehicle, comprising:
a rubber track having a first end and a second end;
and a joint assembly for attaching said first end to said second end.

2- A track assembly, as claimed in claim 1 wherein said joint assembly provides length adjustments.

3- A track assembly, as claimed in claim 1 wherein said joint assembly comprises a link chosen from a set of at least two links, each having a different length.

4- A track assembly as claimed in claim 1, wherein said tire track is mounted on one wheel.

5- A track assembly as claimed in claim 1, wherein said tire track is mounted on more than one wheel.

6- A track assembly as claimed in claim 1, wherein said joint assembly is made of longitudinal side links attached to each said ends.

7- A track assembly as claimed in claim 6, wherein said joint assembly comprises lateral pivots which reinforces said joint assembly and minimizes the open gap.

8- A track assembly as claimed in claim 1, wherein each said end comprises a series of protuberances.

9- A track assembly as claimed in claim 8, wherein each said joint assembly is made of plates clamping the said rubber track segments extremities with fasteners.

10- A track assembly as claimed in claim 1, wherein there are there are two rubber tracks attached end to end.

11- A track assembly for use with a tire equipped vehicle, comprising:
a plurality of rubber track segments, each having a first end and a second end;
and a plurality of joint assemblies;
wherein said track segments allow for use with a plurality of tire diameters, lateral lengths of the said tire track assembly and any given ground surface profile.

12- A track assembly as claimed in claim 11, where said track segments comprise angled side guide edges which provides lateral support and prevents supplementary friction as the said side guides rotates around the tire.

13- A track assembly as claimed in claim 12, where said angled side guide edges prevents interference with respect to one another as the said side guides rotates around the tire.
